(19) United States
(12) Patent Application Publication
(10) Pub. No.: US 2025/0033483 A1
(43) Pub. Date: Jan. 30, 2025

(54) AN ELECTRIC OR HYBRID ELECTRIC-ENDOTHERMIC TRACTION SYSTEM AND A RECONFIGURATION METHOD FOR AN ELECTRIC MACHINE

(71) Applicant: ELDOR CORPORATION S.P.A., Orsenigo (Como) (IT)

(72) Inventors: Javier Eduardo PEREIRA RIVAS, Orsenigo (Como) (IT); Luca ZAI, Orsenigo (Como) (IT); Pasquale FORTE, Orsenigo (Como) (IT); Michele ROMAN, Orsenigo (Como) (IT)

(21) Appl. No.: 18/709,478

(22) PCT Filed: Nov. 10, 2022
(86) PCT No.: PCT/IB2022/060818

§ 371 Date: May 10, 2024

(30) Foreign Application Priority Data
Nov. 12, 2021 (IT) 102021000028766

(51) Int. Cl. B60L 3/00; H02K 3/28; H02P 23/00; H02P 29/032

(52) U.S. Cl. CPC B60L 3/003; B60L 3/0084; B60L 3/0092; H02K 3/28; H02P 23/0086; H02P 29/032; B60L 2220/56; B60L 2240/421; H02K 2213/09

(57) ABSTRACT

An electric or hybrid electric-endothermic traction system, comprises an electric machine, an inverter, a battery, and a switching device configured to switch between a low-speed configuration, wherein the stator windings assume a first electric configuration, and a high-speed configuration, wherein the stator windings assume a second electric configuration, wherein the first electric configuration determines a voltage induced by the rotation of the rotor that, on reaching a pre-determined threshold value of the angular velocity of the rotor, exceeds a supply voltage of the battery pack, while the second electric configuration of the stator windings determines a voltage induced by the rotation of the rotor that is lower than the voltage of the battery for any angular velocity within a field of use of the machine. The switching device switches from the low-speed to the high-speed configuration when the rotor reaches a switching speed lower than or equal to the threshold value.

This invention relates to an electric or hybrid electric-endothermic traction system and a method for reconfiguring an electric machine.

This invention thus finds its main, but not exclusive, application in the sector of traction systems for electric or hybrid vehicles, in particular in controlling variable-configuration electric machines.

In the automotive sector, in fact, the need to design and provide low-emission traction systems that, at the same time, ensure high performance in a wide operating field, providing the user with driving comfort and a level of safety comparable to that of conventional endothermic engines, is always growing.

The issue of safety, though discussed less in the media, is, today, one of the main obstacles to the widespread use of electric vehicles, since achieving similar safety conditions to those of conventional vehicles requires complex and costly control systems.

One of the most long-standing issues in terms of safety is linked to the possibility that, due to a system error or control issues, the drive inverter of the electric machine is disconnected when the machine is in a working area in which it operates as an uncontrolled generator (Uncontrolled Generator Operations—UGO).

This condition translates into a sudden, and uncontrolled, braking action by the electric machine, an occurrence that is scarcely desirable in any application but that, in the automotive sector, becomes absolutely unacceptable and extremely dangerous.

For example, this condition may occur when, in the absence of driving by the inverter, the voltages induced by the rotation of the rotor of the electric machine (back electromotive force-BEMF) tend to exceed the voltage level of the battery pack, thus inverting the power flow from the machine to the battery and suddenly braking the rotor.

This issue is, moreover, felt in designing new-generation electric machines, so-called “variable-configuration” electric machines, wherein the stator windings are segmented to be variably connected to each other, thus enabling a single electric machine to efficiently cover the application field of several motors.

The configuration variation requires, in fact, in some cases, disconnecting the inverter for some fractions of a second, making it essential that this operation occurs in safety.

To avoid risks connected to switching off the inverter in dangerous conditions, in the prior art, an active safety strategy is adopted in terms of software and hardware that involves the closure of the high (or low) inverter legs, thus blocking the spread of the power flow towards the battery pack and making the braking action negligible. This strategy is known in the automotive context as active short circuit.

This strategy, certainly efficient and effective in itself, entails, in any case, a significant increase in product complexity and costs.

The short circuit, purposefully generated to insulate the battery pack, generates a lot of energy that recirculates between two power components: the inverter and the electric machine. As a result, these two components must be oversized in order to support the amount of circulating power. In addition, since the short circuit must be actively generated by the inverter, all the components belonging to this sub-system must always be operating, even in the event of a fault. This means that the power supply, sensors, control logics, and actuation of the inverter must be designed to resist all conditions. In turn, this entails choosing robust components or the creation of redundant branches that make the product more costly and complicated.

The purpose of this invention is, thus, to provide an electric or hybrid electric-endothermic traction system and a method for reconfiguring an electric machine capable of avoiding the drawbacks of the above-mentioned prior art.

In particular, it is the purpose of this invention to provide an electric or hybrid electric-endothermic traction system with a simplified structure and reduced product costs.

An additional purpose of this invention is, thus, to provide an electric or hybrid electric-endothermic traction system and a method for reconfiguring an electric machine that are particularly efficient and reliable.

Said purposes are achieved with an electric or hybrid electric-endothermic traction system and a method for reconfiguring an electric machine that have the features of one or more of the below claims.

In particular, the traction system includes the presence of an electric machine, a switching device, an inverter, and a battery pack.

The electric machine comprises a stator equipped with multiple stator windings (whether wire or bar/hairpin windings) and a rotor housed in the stator and configured to rotate with its own angular velocity that can be varied depending on the operating conditions of the machine.

The switching device is connected to the stator of said electric machine and is configured to switch the stator between a low-speed configuration, wherein the stator windings assume a first electric configuration, and a high-speed configuration, wherein the stator windings assume a second electric configuration.

The stator windings thus have a variable configuration and can be selectively connected in at least two distinct modes in order to assume the first or second electric configuration.

The inverter is connected to the electric machine to drive it, while the battery pack is connected to the electric machine to power it.

According to one aspect of the invention, the first electric configuration of the stator windings determines a voltage induced by the rotation of the rotor that, on reaching a pre-determined threshold value of the rotor's angular velocity, exceeds a supply voltage of the battery pack.

Therefore, in the low-speed configuration, as the angular velocity of the rotor increases, the induced voltage (BEMF) increases until it exceeds the supply voltage of the battery pack.

In contrast, the second electric configuration of the stator windings determines a voltage induced by the rotation of the rotor that is lower than said voltage of the battery pack for any angular velocity within a field of use of the electric machine.

In other words, according to one aspect of the invention, the second configuration is such that, irrespective of the rotor's angular velocity, the electric machine never operates in an operating area in which it can operate as an uncontrolled generator (UGO).

According to a first aspect of the invention, in addition, the switching device is configured to impart to the stator windings a switching from the low-speed configuration to the high-speed configuration when said rotor reaches a switching speed that is lower than or equal to said threshold value.

Therefore, the switching device preferably determines a switching speed (floating or fixed) conferring it with a value that is always below the threshold value, so that, for any angular velocity above said threshold value, the electric machine is found in the high-speed configuration, i.e., a configuration wherein the induced voltages do not exceed the battery's supply voltage.

Advantageously, this eliminates the need for an “active” safety strategy, the system being intrinsically safe and reliable.

In order to maximise this reliability, even overcoming any faults in the control strategy, the system comprises a control unit configured to compare a rotor angular velocity value at a predetermined instant with said threshold value and to disable the switching device if said angular velocity value is greater than said threshold value.

Advantageously, in this way, the control unit does not just perform the switching, via the switching device, before the threshold value is exceeded, but once said value is exceeded, it disables the switching device itself, so as to avoid possible faults in the control ring that could entail the return to the first configuration at speeds that are too high.

In addition, it should be noted that the switching device preferably comprises at least one body that can be moved between a first position, wherein it arranges the stator windings in the first electric configuration, and a second position, wherein it arranges the stator windings in the second electric configuration and an actuator connected to said mobile body to move it between the first and the second position.

The control unit is preferably configured to disable said actuator when said angular velocity value, detected at said predetermined instant, is greater than said threshold value.

Advantageously, therefore, it is the actuator of the switching device to be disabled in the working area for which, in the low-speed configuration, there would be the risk of operating in the condition of an uncontrolled generator.

More preferably, the control unit is configured to send to said switching device two different signals that are “parallel” to each other.

A drive signal that can be selectively switched between a first value, representing the low-speed condition, and a second value, representing the high-speed condition.

An enabling signal that can be selectively switched between a first value, wherein the switching device is enabled to switch, and a second value, wherein the switching device is disabled.

It is to be noted that the switching device is configured to perform the switching only following receipt, by the control unit, of an enabling signal having the first value, strengthening the system in relation to potential faults.

In order to maximise its reliability, it is preferably provided that the control unit is composed of at least one first sub-unit and a second sub-unit, which is arranged operationally in parallel and redundant in relation to said first sub-unit.

The first sub-unit is configured to generate said drive signal.

The second sub-unit is configured to generate said enabling signal.

Advantageously, this structure also prevents any occurrence of faults owing to damage or faults of the individual sub-unit, ensuring at least that the other continues to operate regularly and minimising, if not eliminating, the possibility of reconfiguration in a dangerous speed range.

According to an additional aspect of the invention, which is complementary or alternative to the above, the system comprises an emergency device connected to said switching device, to said control unit, and/or to said inverter.

The emergency device is configured to:
receive a first signal representing an operating condition of said control unit and/or of said inverter from said control unit and/or from said inverter; said first signal being able to assume at least one value, representing the full operation of the control unit and/or of the inverter, and at least one second value, representing a partially or totally inoperative condition of said control unit and/or of said inverter;
send a second signal to said switching device when said first signal assumes said second value.
   Preferably, the second signal is alternatively represented by:
a switching of the stator from the low-speed configuration to the high-speed configuration, if said stator is in the low-speed configuration;
a disabling of the switching device, if said stator is in the high-speed configuration.

Advantageously, in this way, it is possible to maximise the safety of the system in any condition of use, even if the electric machine is switched off (i.e., the inverter is deactivated/non-operational) and dragged into a dangerous working zone by external factors (e.g., primary traction unit or descent).

Additional features and advantages of this invention will be clearer from the indicative, and therefore non-limiting, description of one preferred, but not exclusive, embodiment of an electric or hybrid electric-endothermic traction system and a method for reconfiguring an electric machine, as illustrated in the attached drawings wherein:

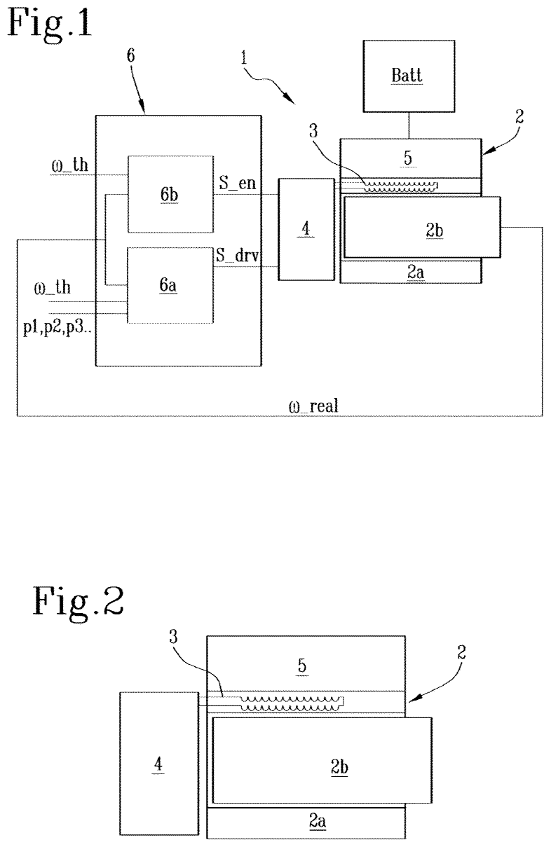

FIG. 1 shows a diagram representing an electric or hybrid electric-endothermic traction system according to this invention, with the electric machine in a first operating configuration;

FIG. 2 schematically shows the electric machine in FIG. 1, in a second operating configuration;

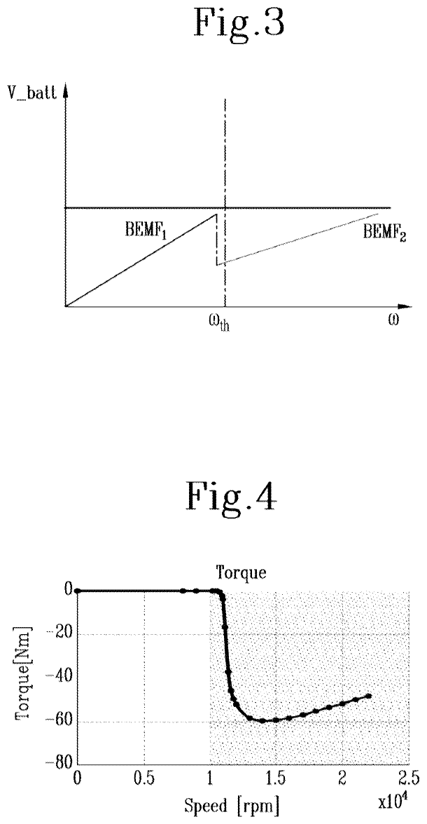

FIG. 3 shows a graphic representing a reconfiguration method of an electric machine according to this invention;

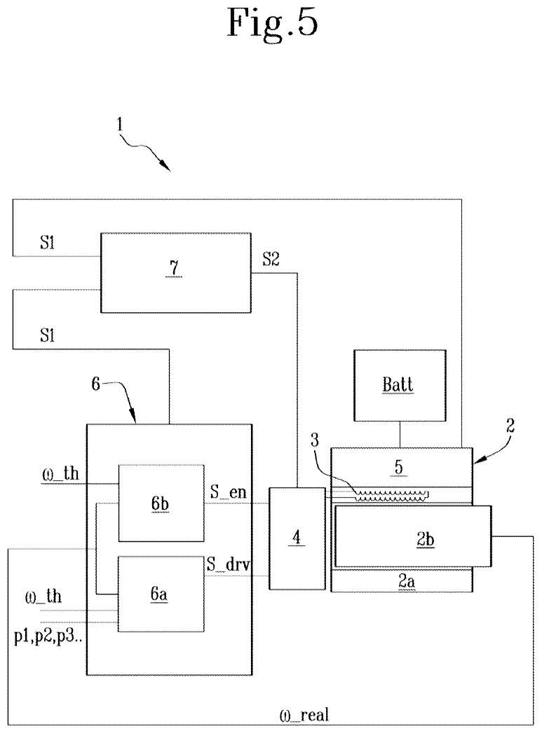

FIG. 4 shows a graphic representing the behaviour of the electric machine, on a torque-velocity plane, in the absence of a suitable control logic;

FIG. 5 shows a diagram representing an electric or hybrid electric-endothermic traction system according to an additional embodiment of this invention.

With reference to the appended figures, the reference number 1 indicates an electric or hybrid electric-endothermic traction system for a vehicle.

The expressions “electric” or “hybrid electric-endothermic” are intended, in this text, to define how the traction system in accordance with the invention is of the type that can be used in any vehicle, land or not, that uses at least one electric traction system, whether it is the primary or secondary one.

This traction system 1 thus comprises at least one electric machine 2, an inverter 5, and a battery pack Batt.

This battery pack Batt is connected to the electric machine 2 through the inverter 5 to power it, with the inverter 5 arranged to drive it depending on the surrounding conditions (operating conditions of the machine, steering by the driver, environmental conditions, etc.).

The battery pack Batt has its own voltage level V_batt, which is preferably around a nominal voltage and varies depending on the charge status of the pack.

The electric machine 2 comprises a stator 2a equipped with multiple stator windings 3 and a rotor 2b housed in the stator 2a.

The rotor 2b is configured to rotate with its own angular velocity ω_real that is variable depending on the operating conditions of the machine (e.g., controls imparted by the inverter 5).

The electric machine 2 can be of various kinds, but is preferably a permanent magnet synchronous machine.

In the preferred embodiment, the stator 2a of the electric machine 2a is of the multi-phase type, preferred embodiment tri-phase (or six-phase).

In other words, in the preferred embodiment, the electric machine 2a comprises at least three stator windings 3.

The stator windings 3 are housed inside the stator casing, known in itself and thus not described in detail.

These windings may be either wire windings, thus defined by coils of copper (or another conductor) suitably wound, or bar windings (or hairpin ones), thus defined by packs of bar conductors suitably twisted and connected.

In addition, the electric machine 2 is preferably of the variable configuration type, i.e., it has stator windings that may be connected to each other in a variable way in order to change the electric configuration thereof, and, thus, the performance of the machine.

In accordance with this, the system 1 preferably comprises a switching device 4 connected to the stator 2a of said electric machine 2.

In particular, the switching device 4 is connected to the stator windings 3 and configured to switch said stator 2a between a low-speed configuration, wherein the stator windings 3 assume a first electric configuration, and a high-speed configuration, wherein the stator windings 3 assume a second electric configuration.

In a first embodiment, for example, the electric machine 2 has multiple stator windings 3, each defining a phase; these windings are, in their turn, fractionated in two or more phase fractions that may be electrically connected in series or parallel.

Alternatively, or in addition, it is the type of connection between the various phases that can be modified, varying, for example, between a star configuration and a triangle configuration or in a combination of the above.

These configurations are known in themselves; thus, they will not be described further.

It should be noted that the switching device 4 may be of various kinds, both electromechanical and semi-conductor.

The electromechanical switching device 4, by way of example described in the patent documents WO2020/194230 and WO2021/079257 in the name of the Applicant, usually comprises a fixed part, which can be bound to the stator 2a and can be connected to the terminals of the stator windings 3 and/or of the fractions of each winding, and a mobile part.

The mobile part, by means of a special actuator, is moveable between a first operating position, wherein it arranges the stator windings 3 in the first electric configuration, and a second operating position, wherein it arranges the stator windings 3 in the second electric configuration.

Alternatively, the switching device can be defined by a semi-conductor device, such as, for example, that described in the patent document WO 2021/099894 belonging to the Applicant, wherein the electrodes of the device are excited in a variable way in order to generate different conductive channels on the substrate, alternatively defining the first or the second (or additional) electric configurations.

It should be noted that the rotation of the rotor 2b inside the stator 2a generates, in the stator windings 3, an induced voltage (back electromotive force) increasing with the angular velocity of the rotor 2b.

According to one aspect of the invention, the first electric configuration of the stator windings 3 is such as to determine a (first) induced voltage BEMF1 that, on reaching a pre-determined threshold value ω_th of the angular velocity of the rotor 2b, exceeds a supply voltage of the battery pack V_batt.

In other words, with the stator windings 3 arranged in the first configuration, as the angular velocity of the rotor grows, the induced voltage grows in a very marked way until intersecting with and exceeding the voltage level of the battery (assumed to be constant).

In contrast, the second electric configuration of the stator windings 3 is such as to determine a (second) voltage induced by the rotation of the rotor BEMF2 that is lower than said voltage of the battery pack V_batt for any angular velocity within a field of use of the electric machine 2.

In other words, with the stator windings 3 arranged in the second configuration, as the angular velocity of the rotor 2b increases, the induced voltage increases in a less marked way in relation to the first electric configuration, keeping below the voltage of the battery pack V_batt for any angular velocity within a field of use of the electric machine 2 (or at least for any speed that can be reached by the vehicle).

In this respect, it should be noted that in the second configuration, the induced voltage could also exceed the voltage level of the battery pack V_batt for high speeds above the limit performance of the vehicle and/or, in any case, that are difficult to reach.

Advantageously, this configuration enables the electric machine 2 to have at least one safety condition, wherein even any faults or switching-off of the inverter does not entail the triggering of an uncontrolled generator operation.

The stator windings 3 preferably comprise multiple phases divided into phase fractions that may be connected to each other via the switching device 4, electrically in series or in parallel.

In the preferred embodiment, the first electric configuration corresponds to the phase fractions connected in series, while the second electric configuration corresponds to the phase fractions connected in parallel.

In this regard, the switching device 4 is preferably configured to impart to the stator 2a a switching from the low-speed configuration to the high-speed configuration when said rotor 2b reaches a switching speed that is lower than or equal to said threshold value ω_th.

It should be noted that the threshold value ω_th could correspond to the intersection value between the curve of the first induced voltage BEMF1 and the battery voltage V_batt or, preferably, a reduced value in relation to this intersection value of a predetermined safety coefficient.

In other words, the switching device 4 is configured to impart to the stator windings a variation from the first electric configuration to the second electric configuration when the rotor 2b reaches a switching speed or switch that is lower than (or equal to) the threshold velocity, preferably lower so as to have a greater safety margin.

In the preferred embodiment, the switching speed is partitioned so as to be lower than said threshold value ω_th of a predetermined safety margin.

It should be noted that, preferably, the traction system comprises a control unit 6 connected to the switching device 4 and to the inverter 5 and configured to communicate with said components.

The control unit 6 is, thus, preferably configured to send to said switching device 4 a drive signal S_drv that can be selectively switched between a first value, representing the low-speed condition, and a second value, representing the high-speed condition.

The control unit 6 is also, preferably, configured to compare a value of the angular velocity ω_real of the rotor, detected or calculated at a predetermined temporal instant, with the threshold value ω_th.

In the preferred embodiment, the control unit 6 operates cyclically and at each cycle n compares the angular velocity ω_real detected in the preceding cycle (n-1) with the threshold value ω_th (potentially also calculated in the previous cycle, if floating).

If the threshold value is floating, the control unit 6 is also configured to determine said threshold value ω_th before said comparison step (i.e., in the previous cycle n-1) and depending on the operating conditions of the electric machine 2 and/or of the charge status of the battery pack Batt.

At the outcome of the comparison, the control unit 6 is configured to communicate with the switching device 4.

The control unit 6 is preferably configured to disable the switching device 4 if said angular velocity ω_real value is greater than said threshold value ω_th (or the switching speed).

Advantageously, thanks to these solutions, the need to introduce active safety systems, which “short-circuit” the inverter, is completely overcome, ensuring safety based only on normal control logics of the electric machine.

In addition, the control unit 6 is preferably configured to send to the switching device 4 an enabling signal S_en that can assume a first, enabling, value and a second, disabling, value.

In other words, the first value of the enabling signal corresponds to a switching device 4 enabled to switch, and the second value corresponds to a switching device 4 disabled from switching.

The control unit 6 is thus configured to send an enabling signal having the second value when the outcome of the comparison determines that the angular velocity ω_real is greater than the threshold value ω_th (or the switching speed).

This control unit 6 is also configured to send an enabling signal having the first value when the outcome of the comparison determines that the angular velocity ω_real is less than the threshold value ω_th (or the switching speed).

The switching device 4 is preferably configured to perform the switching only following receipt, by the control unit 6, of an enabling signal having the first value.

The switching device 4, therefore, has a double input (S_en and S_drv) and is programmed/configured to only perform the switching when it receives:
an enabling signal S_en that has the first value;
a drive signal S_drv having a first or second value representing an electric configuration of the stator windings 3 that is different to the current one (i.e., in the preceding cycle n-1).

In this regard, the control unit 6 preferably comprises a first sub-unit 6a configured to generate said drive signal S_drv and a
a second sub-unit 6b, operationally arranged in parallel and redundant in relation to said first sub-unit 6a, configured to generate said enabling signal S_en.

These sub-units are preferably separate devices positioned on separate supports, so as to maximise the resistance of the system to breakdowns, avoiding that breakdowns or faults in the operation of one of the control (drive) rings lead to the malfunctioning of the other (enabling).

In embodiments in which the switching device 4 is of the electromechanical type (mobile body and actuator), the control unit 6 is configured to disable the actuator when said value ω_real of the current speed is greater than said threshold value ω_th.

In other words, in these embodiments the enabling signal S_en is sent to the actuator and, in particular, to the power source that supplies it.

If the actuator is powered by the battery pack, for example, the control unit 6 is configured to insulate the actuator from the battery pack (e.g., via a switch) if the value ω_real of the current speed is greater than the threshold value ω_th.

In some embodiments, moreover, the switching device 4 comprises holding means connected to the moveable body and configured to counter the free movement of the moveable body as it moves away from the first position and as it moves away from the second position when the switching device is, respectively, in the low-speed configuration or in the high-speed configuration.

In other words, the mobile body of the actuator has a stable condition of equilibrium in each of the positions actively set by the actuator, so as to avoid possible vibrations or collisions from causing an involuntary switching-off of the configuration of the stator windings 3.

In the preferred embodiment, the holding means may be of the elastic type or defined by a suitable conformation of the drive systems that enable the movement of the mobile body between the two positions.

According to another aspect of the invention, in addition, which is alternative or complementary to what has been described until now, the traction system 1 comprises an emergency device 7 connected to said switching device 4, to the control unit 6, and to the inverter 5.

This emergency device 7 is complementary to the control unit 6 and defines a component that is different to the control unit 6 and to the inverter 5, additional to it and arranged on a redundant control ring, useful for maximising the safety and resistance of the system 1 to faults.

This emergency device 7 is, in fact, configured to receive from the control unit 6 and/or from said inverter 5 a first signal S1 representing an operating condition of said control unit 6 and/or of said inverter 5.

The emergency device 7 is preferably configured to receive a first signal both from the control unit 6 and from the inverter 5, so as to maximise the system's efficiency.

Alternatively, the signal could be unique and having an information content representing the state of both the components.

The first signal S1 may preferably assume at least a first value and a second value.

The first value represents the full operation of the control unit 6 and/or of the inverter 5.

The second value represents the partial or total inoperative condition of said control unit 6 and/or of said inverter 5.

Thanks to the first signal S1, thus, the emergency device 7 receives information representing any damage or faults in the control line of the electric machine 2.

The emergency device 7 is, in addition, configured to send to the switching device 4 a second signal S2 when said first signal S1 assumes said second value.

The second signal may represent a switching of the stator 2a from the low-speed configuration to the high-speed configuration, if said stator is in the low-speed configuration.

Alternatively, or in addition, the second signal may represent a disabling of the switching device 4 if said stator is in the high-speed configuration.

This second signal S2, thus, may be defined by two different signals, each having a corresponding information content or by a single signal that contains both contributions.

Advantageously, in this way, if a fault or malfunction should occur, or simply when the inverter 5 is switched off on purpose by the vehicle control unit, the emergency device 7 is able to reconfigure or keep the electric machine in a condition of safety, corresponding to the high-speed configuration (in which the induced voltages do not exceed the battery voltage V_batt).

The emergency device, thus, is able to “force” the reconfiguration or actively disable it, even if the control unit 6 does not involve this condition.

Think, for example, of the use of an electric traction unit to support a primary unit, which if inactive (e.g., switched off) could be dragged to speeds above the threshold value ω_th entailing all the risks described above.

Thanks to the emergency device, the system 1 manages to avoid this drawback, achieving greater safety even if the control ring of the switching device does not involve the reconfiguration below the threshold speed ω_th (for example, because it is switched off).

In an alternative embodiment, the second signal S2 can be continuously sent by the emergency device 7 to the switching device 4; in this case, the second signal S2 may assume at least two different values, one that does not impart any action and one that acts actively on the switching device 4 (reconfiguring and/or disabling).

In the preferred embodiment, the emergency device 7 is defined by an SBC device configured to receive, as input, the first signal S1 (or the first signals S1) and to replace, as output, along a control branch parallel to that of the control unit 6, the second signal S2 (or the second signals S2).

The subject of this invention is also a reconfiguration method for a variable-configuration electric machine 2 powered by a battery pack Batt, which preferably, but not exclusively, is actuated by the system described up to here.

We will proceed, therefore, below to describe the method in more detail, underlining that until now all the features mentioned and described in relation to the system 1, where not expressly identified or if incompatible, are to be considered applicable mutatis mutandis to the following description of the method that is the subject of this invention.

In accordance with the invention, the method involves determining the angular velocity of the rotor ω_real and switching the stator windings 3 from the first configuration to the second configuration when said rotor 2b reaches a switching velocity that is lower than said threshold value ω_th.

As already clarified in the description of the system, this in fact ensures the operation of the electric machine 2 within a safe working range, wherein uncontrolled generator operation does not occur.

The method preferably involves, first, comparing a value of the angular velocity ω_real of the rotor to a predetermined instant (previous) with the threshold value ω_th (possibly pre-calculated, as described above) and disabling any switching from the second configuration to the first if said value of the angular velocity ω_real is greater than said threshold value ω_th.

The invention achieves the purposes proposed and entails significant advantages.

In fact, the presence of a traction system that enables the machine to always operate in safe working areas, while keeping a high and wide operating range, makes it possible to avoid the drawbacks of the prior art.

The use of stator windings that make it possible to have a high-speed configuration that does not lead to uncontrolled generator operation and a control that imparts the switching to suitable speeds enables avoiding risks in the machine's normal operation.

In addition, the arrangement of a parallel disabling channel, redundant and additional to the drive line/ring of the switching device, significantly increases the safety level and reliability of the system, making it resistant to various types of errors.

In particular, thanks to these solutions, the need to introduce active safety systems, which “short-circuit” the inverter, is completely overcome, ensuring safety based only on normal control logics of the electric machine.

Thanks to these measures, the system is, thus, reliable and, at the same time, simple and cost-effective for the manufacturer.

In addition, if present, the use of an emergency device makes it possible to maximise the reliability of the system, avoiding the implementation of braking torque even in conditions for which the control ring of the switching system could not operate.

1. An electric or hybrid electric-endothermic traction system, comprising:
an electric machine comprising a stator equipped with multiple stator windings and a rotor housed in the stator and configured to rotate with an angular velocity (ω_real) that varies depending on the machine's operating conditions;
a switching device connected to the stator of said electric machine and configured to switch said stator between a low-speed configuration, wherein the stator windings take a first electric configuration, and a high-speed configuration, wherein the stator windings take a second electric configuration;
an inverter connected to said electric machine in order to drive it;
a battery pack (Batt) connected to said electric machine to supply power to it; wherein:
said first electric configuration of the stator windings determines a voltage induced by the rotation of the rotor (BEMF1) that, on reaching a pre-determined threshold value (ω_th) of the angular velocity of the rotor, exceeds a supply voltage of the battery pack (V_batt);
said second electric configuration of the stator windings determines a voltage induced by the rotation of the rotor (BEMF2) that is lower than said voltage of the battery pack (V_batt) for any angular velocity within a field of use of the electric machine;
and wherein said switching device is configured to impart to the stator a switching from the low-speed configuration to the high-speed configuration when said rotor reaches a switching speed that is lower than or equal to said threshold value (ω_th).

2. The traction system according to claim 1, wherein the traction system comprises a control unit configured to:
compare a value of the angular velocity (ω_real) of the rotor in a pre-determined moment with said threshold value (ω_th);
disable the switching device if said angular velocity (ω_real) is greater than said threshold value (ω_th).

3. The traction system according to claim 2, wherein said control unit is configured to determine said threshold value (ω_th) before said comparison step and depending on the operating conditions of the electric machine and/or of the charge status of the battery pack (Batt).

4. The traction system according to claim 2, wherein said switching device comprises:
at least one body moveable between a first position, wherein it arranges the stator windings in the first electric configuration, and a second position, wherein it arranges the stator windings in the second electric configuration;
an actuator connected to said moveable body to move it between the first and second position.

5. The traction system according to claim 4, wherein said control unit is configured to disable said actuator when said value (ω_real) of the current speed is greater than said threshold value (ω_th).

6. The traction system according to claim 2, wherein said control unit is configured to send to said switching device:
a drive signal (S_drv) that can be selectively switched between a first value, representing the low-speed condition, and a second value, representing the high-speed condition;
an enabling signal (S_en) that can be selectively switched between a first value, wherein the switching device is enabled to switch, and a second value, wherein the switching device is disabled;
wherein said switching device is configured to perform the switch only following receipt, by the control unit, of an enabling signal having the first value.

7. The traction system according to claim 6, wherein said control unit comprises:
a first sub-unit configured to generate said drive signal (S_drv);
a second sub-unit, operationally arranged in parallel and redundant in relation to said first sub-unit, configured to generate said enabling signal (S_en).

8. The traction system according to claim 6, wherein said switching device comprises holding means connected to said moveable body and configured to counter the free movement of the moveable body as it moves away from the first position and as it moves away from the second position when the switching device is, respectively, in the low-speed configuration or in the high-speed configuration.

9. The traction system according to claim 1, comprising an emergency device connected to said switching device, to said control unit, and/or to said inverter and configured to:
receive a first signal representing an operating condition of said control unit and/or of said inverter from said control unit and/or from said inverter; said first signal being able to assume at least one value, representing the full operation of the control unit and/or of the inverter, and at least one second value, representing a partially or totally inoperative condition of said control unit and/or of said inverter;
send a second signal to said switching device when said first signal assumes said second value, wherein said second signal is alternately representing:
a switching of the stator from the low-speed configuration to the high-speed configuration, if said stator is in the low-speed configuration;
a disabling of the switching device, if said stator is in the high-speed configuration.

10. A reconfiguration method for an electric machine powered by a battery pack (Batt), said electric machine comprising:
a stator equipped with multiple stator windings that can be selectively switched between a first electric configuration and a second electric configuration;
a rotor housed in the stator and configured to rotate with an angular velocity (ω_real) that varies depending on the machine's operating conditions;
wherein said first electric configuration of the stator windings determines a voltage induced by the rotation of the rotor (BEMF1) that, on reaching a pre-determined threshold value (ω_th) of the angular velocity of the rotor, exceeds a supply voltage of the battery pack (V_batt);
said second electric configuration of the stator windings determines a voltage induced by the rotation of the rotor (BEMF2) that is lower than said voltage of the battery pack (V_batt) for any angular velocity within a field of use of the electric machine;
said reconfiguration method comprising the following steps:
determining the angular velocity of the rotor (ω_real);
switching the stator windings from the first configuration to the second configuration when said rotor reaches a switching velocity that is lower than said threshold value (ω_th).

11. The method according to claim 10, comprising the steps of:
comparing a value of the angular velocity (ω_real) of the rotor in a pre-determined moment with said threshold value (ω_th);
disabling any switching between the first and second configuration, and vice versa, if said angular velocity (ω_real) is greater than said threshold value (ω_th).

12. The method according to claim 10, comprising a step for determining said threshold value (ω_th) before said comparison step and depending on the operating conditions of the electric machine and/or of the charge status of the battery pack (Batt).
